(19) United States
(12) Patent Application Publication
(10) Pub. No.: US 2019/0069572 A1
(43) Pub. Date: Mar. 7, 2019

(54) METHOD OF PRODUCING A COFFEE EXTRACT

(71) Applicant: NESTEC S.A., Vevey (CH)

(72) Inventors: Christoph Reh, Epalinges (CH); Stefan Palzer, Lausanne 26 (CH); Rachid Bel-Rhlid, Savigny (CH); Edwin Ananta, Epalinges (CH)

(21) Appl. No.: 15/757,038

(22) PCT Filed: Sep. 2, 2016
(86) PCT No.: PCT/EP2016/070689

§ 371 Date: Mar. 2, 2018

(30) Foreign Application Priority Data
Sep. 4, 2015 (EP) 15183907.3

(51) Int. Cl. A23F 5/24; A23F 5/10; A23F 5/28; A23F 5/26

(52) U.S. Cl. CPC A23F 5/246; A23F 5/26; A23F 5/28; A23F 5/10

(57) ABSTRACT

The present invention relates to a method of producing a coffee extract wherein coffee beans are contacted with cellulase and xylanase.

### FIELD OF THE INVENTION

The present invention relates to a method of producing a coffee extract wherein coffee beans are contacted with enzyme.

### BACKGROUND

High temperatures are often used during industrial extraction of coffee beans, e.g. for the production of soluble, or instant, coffee products, in order to achieve hydrolysis and solubilisation of carbohydrates in the coffee beans. The solubilisation of the carbohydrates is important to achieve the desired yield of the extraction process and the carbohydrates may help to stabilise compounds of the coffee extract during storage. The high temperatures used to achieve hydrolysis of carbohydrates may lead to degradation and/or loss of desired compounds, e.g. aroma compounds, and in some cases to the formation of undesired compounds in the coffee extract. It has been proposed to use enzymes to hydrolyse the carbohydrates in an effort to avoid the undesired effects of high temperatures. For example, EP 1 745 702 discloses a method of producing a coffee extract wherein roast and ground coffee is combined with water and mannanase or a mixture of mannanase and cellulase is added to the mixture of roast and ground coffee and water. Use of enzymatic hydrolysis has not found widespread application and there is still a need to find improved ways of extracting carbohydrates from coffee under mild conditions. Furthermore, the remains of conventional coffee extraction, e.g. for the production of soluble coffee, so-called spent coffee grounds, i.e. the coffee particles being left when roast and ground coffee beans have been extracted with water, contain carbohydrates which are not completely extracted by conventional means. These carbohydrates may be useful as ingredients in food and beverage products, e.g. as sweeteners, bulking agents, texturiser, etc. There is therefore a need for methods to extract and valorise these carbohydrates.

### SUMMARY OF THE INVENTION

The present inventors have now found that the use of a specific combination of enzymes increases the degree of hydrolysis of carbohydrates and the yield obtained from extraction of coffee. Accordingly, the present invention relates to a method of producing a coffee extract, the method comprising the following steps: a) contacting coffee beans with an enzyme preparation comprising cellulase and xylanase; and b) extracting said coffee beans with an aqueous liquid to produce a coffee extract.

### DETAILED DESCRIPTION OF THE INVENTION

Definitions

By cellulase is understood an enzyme with enzymatic activity of enzyme class EC 3.2.1.4 which catalyses the endohydrolysis of (1→4)-beta-D-glucosidic linkages in cellulose, lichenin and cereal beta-D-glucans and may also hydrolyze 1,4-linkages in beta-D-glucans also containing 1,3-linkages. A cellulase may have only cellulase activity or may additionally have one or more side activities, i.e. other enzymatic activities in addition to cellulase activity.

By xylanase is understood an enzyme with enzymatic activity of enzyme class EC 3.2.1.8, also called endo-1,4-beta-xylanase, which catalyses the endohydrolysis of (1→4)-beta-D-xylosidic linkages in xylans. A xylanase may have only xylanase activity or may additionally have one or more side activities, i.e. other enzymatic activities in addition to xylanase activity.

By beta-mannanase is understood an enzyme with enzymatic activity of enzyme class EC 3.2.1.78, also called mannan endo-1,4-beta-mannosidase, which catalyses random hydrolysis of (1→4)-beta-D-mannosidic linkages in mannans, galactomannans and glucomannans. A beta-mannanase may have only beta-mannanase activity or may additionally have one or more side activities, i.e. other enzymatic activities in addition to beta-mannanase activity.

By beta-glucosidase is understood an enzyme with enzymatic activity of enzyme class EC 3.2.1.21, also called beta-D-glucoside glucohydrolase or cellobiase, which catalyses the hydrolysis of terminal, non-reducing beta-D-glucosyl residues with release of beta-D-glucose. A beta-glucosidase may have only beta-glucosidase activity or may additionally have one or more side activities, i.e. other enzymatic activities in addition to beta-glucosidase activity.

EC (Enzyme Committee) numbers refer to the definition of enzymatic activity and nomenclature given by the Nomenclature Committee of the International Union of Biochemistry and Molecular Biology as in force on 16 Dec. 2014.

By an “enzyme preparation” is understood a composition comprising one or more enzymes and having one or more enzymatic activities. An enzyme preparation may e.g. be a mixture of purified enzymes or it may be a crude preparation comprising one or more enzymes, e.g. in the form of a cell extract of a microorganism.

### METHOD OF THE INVENTION

According to the method of the present invention coffee beans are contacted with an enzyme preparation comprising cellulase and xylanase. Coffee beans are the seeds of the coffee plant (Coffea), and coffee beans according to the present invention may be derived from any variety of coffee, e.g. Arabica coffee (Coffea arabica) or Robusta coffee (Coffea canephora). The coffee beans may be raw (so-called green coffee beans) or they may be roast. By roast coffee beans are meant coffee beans that have undergone a heat treatment to impart the typical flavour, aroma and colour of roast coffee. The coffee beans may be treated in any suitable way to obtain the desired characteristics of the coffee extract of the invention and/or in any suitable way to facilitate the enzymatic reaction and/or the extraction of the beans with an aqueous liquid. In a preferred embodiment the coffee beans are ground coffee beans. Any suitable method of grinding may be used to produce ground coffee beans, such methods are well-known in the art of coffee processing. Coffee beans may be ground before and/or after contact with an enzyme preparation. The coffee beans may be contacted with water before and/or during the contact with the enzyme preparation, for example, the coffee beans may be dispersed in an aqueous liquid before and/or during the contact with an enzyme preparation. The coffee beans used in the method of the invention may have been subjected to an extraction process to remove soluble compounds before being contacted with an enzyme preparation. In a preferred embodiment of the invention, the coffee beans have been subjected to extraction with an aqueous liquid before being contacted with an enzyme preparation. For example, the coffee beans may be so-called spent grounds, coffee grounds left from a conventional extraction process such as used for the production of soluble coffee. If spent grounds are used, the method of the invention may be used to extract additional carbohydrates from the spent grounds that were not extracted during the first extraction. The compounds extracted may be used for different purposes, e.g. if the spent grounds have been extracted to produce a soluble coffee product the carbohydrates may be used in the production of this soluble coffee products, e.g. by adding the carbohydrates to the extract already obtained before the contract with an enzyme preparation. The carbohydrates may also be useful for a number of other uses, e.g. as ingredients, e.g. as sweeteners or texturisers, in food and beverage products or as ingredients in other products. In this way the method of the invention can e.g. be a way of utilising spent grounds from a conventional extraction process. The obtained carbohydrates may be further purified and/or fractionated to obtain preparations with specific carbohydrate compositions depending on the intended use of the carbohydrates.

The enzyme preparation used to contact the coffee beans in the method of the invention comprises cellulase and xylanase. Additionally, the enzyme preparation may comprise other enzymatic activities. In a preferred embodiment, the enzyme preparation further comprises beta-mannanase. In another preferred embodiment the enzyme preparation comprises beta-glucosidase. In a specific embodiment the enzyme preparation comprises cellulase, xylanase and beta-mannanase; in another specific embodiment the enzyme preparation comprises cellulase, xylanase and beta-glucosidase; in yet another specific embodiment the enzyme preparation comprises cellulase, xylanase, beta-mannanase and beta-glucosidase.

The enzyme preparation may be derived from any suitable source. It may e.g. be in the form of an extract of microbial cells comprising the desired enzymatic activities, or it may e.g. be in the form of a mixture of extracts of two or more different microbial cells. Cell extracts may have undergone purification to remove undesired components, e.g. undesired enzymatic activities, and/or to increase the concentration of desired enzymes.

The enzyme preparation may also be a mixture of purified enzymes or it may be a mixture of one or more cell extracts and one or more purified enzymes.

Suitable enzymes may e.g. be from a microbial source (bacteria, fungi, yeast) e.g. from Aspergillus sp., Bacillus sp., Trichoderma sp., Cellulomonas Sp., Clostridium sp., Penicillium sp., Fusarium sp., Saccharomyces sp., Solanum sp., Vibrio sp., Streptomyces sp., Lactobacillus sp., and/or Rhizopus sp.; from an animal source e.g. from a marine invertebrate (such as scallop), a termite, an insect, a crayfish, a protozoan, a snail, and/or acrustacean; and/or from plant source, e.g. from marine algae, olives, and/or almonds.

Suitable commercial cellulases are e.g. Cellulase 13L, Depol 40L, Depol 793L, all from Biocatalysts, Cardiff, UK; Cellic CTec2, HTech2, and Carezyme 1000L, all from Novozymes A/S, Bagsvaerd, Denmark.

Suitable commercial xylanases are e.g. Depol 33MDP, Glucanase 5XL, both from Biocatalyst, Cardiff, UK, and Panzea from Novozymes A/S, Bagsvaerd, Denmark.

A suitable commercial beta-mannanase is e.g. Mannaway-S3 from Novozymes A/S, Bagsvaerd, Denmark.

Suitable commercial beta-glucosidases are e.g. Depol 392L, Depol 670L, both from Biocatalysts, Cardiff, UK, and Viscozyme L from Novozymes A/S, Bagsvaerd, Denmark.

Contacting coffee beans with an enzyme preparation may be performed in any suitable manner. The enzyme preparation is preferably in the form of an aqueous solution which is contacted with the coffee beans, e.g. by spraying the solution unto the coffee beans and/or immersing the coffee beans into the solution. The concentration of enzymes in the solution (the enzymatic activity of the solution), the duration of contact, and the conditions of the contact (such as e.g. the temperature during contact, the amount of enzyme solution, and the pH of the enzyme solution) should be chosen in such a way as to obtain the desired degree of enzymatic conversion of carbohydrates in the coffee beans. Such conditions can be chosen and optimised by the skilled person using routine methods and/or utilising knowledge about the enzymes and their optimum conditions of activity.

The coffee beans are extracted with an aqueous liquid to produce a coffee extract. Methods of extracting coffee beans with aqueous liquid are well-known in the art. The extraction may be performed during and/or after the contacting of the coffee beans with an enzyme preparation. For example, the contacting with an enzyme may be performed separately before the extraction. In this case the beans may be rinsed to remove enzyme before extraction and/or they may be treated to inactivate the enzymes, e.g. by heat. In another embodiment enzyme solution used to contact the beans with enzyme may also serve as extraction liquid. If desired the enzyme may be inactivated when the desired degree of enzymatic conversion has been reached, e.g. by increasing the extraction temperature to a temperature at which the enzymes are denatured. Extraction of the coffee beans may be performed at any suitable temperature. An advantage of the method of the present invention is that carbohydrates can be extracted after enzymatic conversion at lower temperatures than are normally used during extraction to achieve hydrolysis and extraction of carbohydrates from coffee beans, e.g. during conventional production of soluble coffee wherein temperatures of 120-180° C. are often used. In a preferred embodiment of the present invention the coffee beans are extracted at a temperature between 60 and 150° C., more preferably between 70 and 140° C., most preferably between 80 and 120° C. In another preferred embodiment the temperature does not exceed 140° C., more preferably 120° C. during extraction of the coffee beans.

Coffee aroma may be recovered from the coffee beans before said coffee beans are extracted with an aqueous liquid to produce a coffee extract and the coffee aroma added back to the coffee extract after extraction. It is well known in the art of soluble coffee production to remove aroma from coffee beans before extracting the coffee beans to avoid loss of aroma during the extraction step. This aroma is then added back to the coffee extract, in the case of powdered soluble coffee products usually just before the drying of the liquid extract to a powder.

The coffee extract may be dried to produce a dry coffee extract, e.g. in powder form. Drying may be performed by any suitable method, e.g. by spray drying or freeze drying. A dried coffee extract may be in the form of an instant coffee product useful for preparing a coffee beverage by dissolving the instant coffee product, e.g. in hot water or milk. A dried coffee extract may be mixed with other ingredients useful for producing an instant coffee beverage powder, e.g. sweetener such as sugar, creamer, milk powder, aroma, and the like. The coffee extract may also be used in liquid form, e.g. for a so-called RTD (ready-to-drink) coffee beverage.

A preferred embodiment of the method of the invention for producing a coffee extract comprises the following steps:

a) contacting roast and ground coffee beans with an enzyme preparation comprising cellulase and xylanase; and

b) extracting said coffee beans with an aqueous liquid to produce a coffee extract.

Another preferred embodiment of the method of the invention for producing a coffee extract comprises the following steps:

a) contacting roast and ground coffee beans with an enzyme preparation comprising cellulase, xylanase, beta-mannanase and beta-glucosidase; and

b) extracting said coffee beans with an aqueous liquid to produce a coffee extract.

### EXAMPLES

### Example 1

### Hydrolysis of SGC with Different Enzymes

Coffee beans in the form of particles of roast and ground coffee beans having been subjected to a conventional extraction process for the production of soluble coffee were subjected to enzymatic hydrolysis by different enzymes and enzyme combinations.

The hydrolysis was performed at 30° C. or 50° C., using 1% SGC and 50 μg/m1 of enzyme in 50 mM maleate buffer at pH 5.0 or pH 7.0 for 15 min to 24 h.

HPLC Analyses of Produced Sugars

To establish HPLC analysis different standards were detected using an Agilent Technology 1260 Infinity Quaternary LC system with following components: sampler 1260 ALS, pump 1260 Quat pump, detector 1260 RID. Different columns (Hi-Plex Na and Hi-Plex H) were tested to determine best separation results. Water was used as eluent with a flow rate of 0.5 mL/min.

Retention times in minutes were determined for the following standards: glucose: 9.376 cellobiose: 7.891 xylose: 9.978, xylobiose: 8.308, mannose: 9.87, galactose: 9.894, arabinose: 10.706.

The following enzymes were used:

Cellulase (Cell): Celluclast CL 1.5 L from Trichoderma reesei (Novozymes, Bagsverd, Denmark)

Mannanase (Man): Mannaway-S3 (Novozymes, Bagsverd, Denmark)

Xylanase (Xyn): Endol-4 β-Xylanase from Aspergillus niger (Megazyme)

Beta-glucosidase (Bgl) (Institute of Technical Microbiology, University of Hamburg, Germany).

Relative activity values relate the measured optical densities in parallel experiment under certain conditions directly to each other. Therefore, the highest absorption value (λ=546 nm) is set equal to 100% activity whereupon the other measured values correlate accordingly.

The relative activity of an enzyme (in Units/μl) in the reaction tube is defined as the total enzyme units (in reaction tube) divided by the volume of added extract. The relative activity was determined assuming the activity of the enzymes under optimal conditions to be 100%. The relative activity of the enzymes and various combinations are shown in Table 1.

TABLE 1
Relative activity of different enzymes and enzyme combinations on
roast and ground coffee beans previously extracted by water.

| Enzyme(s) | Relative activity (%) |
|---|---|
| Cell | 58 |
| Man | 3 |
| Xyn | 73 |
| Cell + Bgl | 60 |
| Cell + Man | 53 |
| Cell + Xyn | 95 |
| Cell + Bgl + Man + Xyn | 99 |

1. A method of producing a coffee extract, the method comprising the steps:
a) contacting coffee beans with an enzyme preparation comprising cellulase and xylanase; and
b) extracting the coffee beans with an aqueous liquid to produce a coffee extract.

2. The method of claim 1 wherein the enzyme preparation in step a) further comprises beta-mannanase.

3. The method of claim 1 wherein the enzyme preparation in step a) further comprises beta-glucosidase.

4. The method of claim 1 wherein the coffee beans are roast coffee beans.

5. The method of claim 1 wherein the coffee beans are ground coffee beans.

6. The method of claim 1 wherein the coffee beans have been subjected to extraction with an aqueous liquid before step a).

7. The method of claim 1 wherein the coffee extract is dried after step b).

8. The method of claim 1 wherein the enzyme preparation is in the form of an aqueous solution which is contacted with the coffee beans

9. The method of claim 1 wherein the coffee are contacted with water before and/or during the contact with an enzyme preparation.

10. The method of claim 1 wherein coffee aroma is recovered from the coffee beans before the coffee beans are extracted with an aqueous liquid to produce a coffee extract and the coffee aroma is added back to the coffee extract after extraction.

11. The method of claim 1 wherein the coffee beans are extracted at a temperature between 60 and 150° C. in step b).
